(19) United States
(12) Patent Application Publication
(10) Pub. No.: US 2026/0004143 A1
(43) Pub. Date: Jan. 1, 2026

(54) REINFORCED LEARNING FOR TOPOLOGY GENERATION OF A NETWORK-ON-CHIP

(71) Applicant: ARTERIS, INC., Campbell, CA (US)

(72) Inventors: Amir CHARIF, Paris (FR); Ugo LECERF, Paris (FR); Donatello CONTE, Paris (FR)

(73) Assignee: ARTERIS, INC., Campbell, CA (US)

(21) Appl. No.: 19/257,390

(22) Filed: Jul. 1, 2025

Related U.S. Application Data
(60) Provisional application No. 63/666,244, filed on Jul. 1, 2024.

(51) Int. Cl. G06N 3/092; G06N 3/042

(52) U.S. Cl. CPC G06N 3/092; G06N 3/042

(57) ABSTRACT

A computer-implemented method includes loading a simplistic network-on-chip (NoC) topology that is fully routed, and performing reinforcement learning on the NoC topology to identify a sequence of topology transformations that will produce a more optimal NoC topology. Performing the reinforcement learning includes running a plurality of training sessions. Running each training session includes using a machine learning model to apply a set of transformations to the NoC topology according to a policy, computing a cost of the NoC topology after the set of transformations has been applied, and updating the policy in response to the cost.

### CROSS REFERENCE TO RELATED APPLICATION

This application claims the benefit under 35 U.S.C. 119(e) of U.S. Provisional Application Ser. No. 63/666,244 filed on Jul. 1, 2024 and titled SYSTEM AND METHOD FOR TOPOLOGY GENERATION USING ARTIFICIAL INTELLIGENCE by Amir CHARIF et al., the entire disclosure of which is incorporated herein by reference.

### TECHNICAL FIELD

The present technology is in the field of electronic computer aided design of electronic systems and, more specifically, related to topology synthesis of a network-on-chip (NoC).

### BACKGROUND

Network-on-chip technology is being used at many semiconductor companies to support an ever-increasing number of cores on a single chip and satisfy a demand for ever-increasing processing power related to artificial intelligence (AI) and other applications. A NoC is superior to old point-to-point connectivity by way of a more scalable communication architecture that makes use of packet transmissions.

During design of a NoC, a NoC topology is generated. A NoC topology refers to a general layout of NoC elements (e.g., network interface units, buffers, switches, pipes, probes, firewalls, and adapters) and electrical connections between the NoC elements. Multiple iterations of the NoC topology may be generated until certain criteria are satisfied.

It would be desirable to use a machine learning model to generate a NoC topology. However, training a machine learning model to “learn” certain concepts in NoC design is extremely challenging. These concepts include connectivity (existence of a path between each source and destination); packet routing (computing a route in the NoC topology from a source to a destination); and deadlock avoidance.

Moreover, concepts such as deadlock avoidance should not be entrusted to a statistical model but rather should be a mathematical certainty. Even if unlikely, a deadlock could put a NoC in a stalled state during runtime. The deadlock could be resolved by resetting the NoC, but resetting the NoC is not desirable.

### SUMMARY

In accordance with various embodiments and aspects of the invention, a computer-implemented method includes loading a simplistic NoC topology that is fully routed, and performing reinforcement learning on the NoC topology to identify a sequence of topology transformations that will produce a more optimal NoC topology. Performing the reinforcement learning includes running a plurality of training sessions. Running each training session includes using a machine learning model to apply a set of transformations to the NoC topology according to a policy, computing a cost of the NoC topology after the set of transformations has been applied, and updating the policy in response to the cost.

In accordance with various embodiments and aspects of the invention, an electronic computer aided design (ECAD) tool includes computer-readable memory encoded with code for designing a NoC topology. The code, when executed by a computer system, causes the computer system to load a simplistic NoC topology that is fully routed, and perform reinforcement learning on the NoC topology to identify a sequence of topology transformations that will produce a more optimal NoC topology. The reinforcement learning includes running a plurality of training sessions. Each training session includes using a machine learning model to apply a set of transformations to the NoC topology according to a policy, computing a cost of the NoC topology after the set of transformations has been applied, and updating the policy in response to the cost.

In accordance with various embodiments and aspects of the invention, a computer system includes a processing unit, and computer memory encoded with code that, when executed by the processing unit, causes the computer system to load a simplistic NoC topology that is fully routed, and perform reinforcement learning on the NoC topology to identify a sequence of topology transformations that will produce a more optimal NoC topology. The reinforcement learning includes running a plurality of training sessions. Each training session includes using a machine learning model to apply a set of transformations to the NoC topology according to a policy, computing a cost of the NoC topology after the set of transformations has been applied, and updating the policy in response to the cost.

### BRIEF DESCRIPTION OF THE DRAWINGS

In order to understand the invention more fully, reference is made to the accompanying drawings. The invention is described in accordance with the aspects and embodiments in the following description with reference to the drawings or figures (FIG.), in which like numbers represent the same or similar elements. Understanding that these drawings are not to be considered limitations in the scope of the invention, the presently described aspects and embodiments and the presently understood best mode of the invention are described with additional detail through use of the accompanying drawings.

FIG. 1 illustrates an example network-on-chip (NoC) including various NoC elements.

FIG. 2 illustrates a method of designing a NoC in accordance with various aspects and embodiments of the invention.

FIG. 3 illustrates a simple example of a NoC topology.

FIG. 4 illustrates an example floorplan onto which a NoC will be implemented.

FIG. 5 illustrates a connectivity table for a NoC and a table with flags that enable specific communication policies for different traffic classes.

FIG. 6 illustrates a simplistic NoC topology created in accordance with the various aspects and embodiments of the invention.

FIG. 7 illustrates decomposition of main switches of the simplistic NoC topology of FIG. 6 into mergers and splitters in accordance with the various aspects and embodiments of the invention.

FIG. 8 illustrates a roadmap for an initiator network interface unit (NIU) in the NoC topology of FIG. 6 in accordance with the various aspects and embodiments of the invention.

FIG. 9 illustrates a roadmap for a target NIU in the NoC topology of FIG. 6 in accordance with the various aspects and embodiments of the invention.

FIG. 10 illustrates decomposition of a main splitter into a cascade of splitters distributed physically along a splitter roadmap in accordance with the various aspects and embodiments of the invention.

FIG. 11 illustrates decomposition of a main merger into a cascade of mergers distributed physically along a merger roadmap in accordance with the various aspects and embodiments of the invention.

FIG. 12 illustrates an two neighboring switches that are fused in accordance with the various aspects and embodiments of the invention.

FIG. 13A and FIG. 13B illustrate a NoC subnetwork before and after wire optimization in accordance with the various aspects and embodiments of the invention.

FIG. 14 is graph that represents a simplistic NoC topology.

FIG. 15 illustrates a method of using reinforcement learning to optimize a NoC topology in accordance with the various aspects and embodiments of the invention.

FIG. 16 illustrates a tree search algorithm in accordance with the various aspects and embodiments of the invention.

FIG. 17 illustrates a computer system in accordance with various aspects and embodiments of the invention.

### DETAILED DESCRIPTION

The following describes various examples of the present technology that illustrate various aspects and embodiments of the invention. Generally, examples can use the described aspects in any combination. All statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one aspect,” “an aspect,” “certain aspects,” “various aspects,” or similar language means that a particular aspect, feature, structure, or characteristic described in connection with any embodiment is included in at least one embodiment of the invention.

Appearances of the phrases “in accordance with one or more embodiments,” “in one embodiment,” “in at least one embodiment,” “in an embodiment,” “in certain embodiments,” and similar language throughout this specification may, but do not necessarily, all refer to the same embodiment or similar embodiments. Furthermore, aspects and embodiments of the invention described herein are merely exemplary, and should not be construed as limiting of the scope or spirit of the invention as appreciated by those of ordinary skill in the art. The disclosed invention is effectively made or used in any embodiment that includes any novel aspect described herein. All statements herein reciting principles, aspects, and embodiments of the invention are intended to encompass both structural and functional equivalents thereof. It is intended that such equivalents include both currently known equivalents and equivalents developed in the future.

As used herein, a “master” and a “initiator” refer to similar intellectual property (IP) modules or units and the terms are used interchangeably within the scope and embodiments of the invention. As used herein, a “slave” and a “target” refer to similar IP modules or units and the terms are used interchangeably within the scope and embodiments of the invention.

As used herein, a NoC element refers to a distribution point and/or a communication endpoint in a NoC that is capable of creating, receiving, and/or transmitting information over a communication path or channel. NoC elements may include, without limitation, network interface units (NIUs), switches, buffers, pipes, probes, firewalls, and adapters.

As used herein, splitters and mergers are switches, but not all switches are splitters or mergers. As used herein, the term “splitter” refers to a switch that has a single ingress port and multiple egress ports. As used herein, the term “merger” refers to a switch that has a single egress port and multiple ingress ports.

The following examples describe electronic computed aided design of a NoC for an electronic system implemented in a system-on-chip (SoC). An SoC includes initiators and targets, which communicate via a NoC. Examples of the initiators include central processing units (CPUs), graphics processing units (GPUs), video cards, accelerators, and direct memory access (DMA) controllers. Examples of the targets include volatile memory, persistent memory, and peripherals.

During operation of an SoC, an initiator may send a request transaction to a target using an address to select the target. Examples of request transactions include write requests and read requests. The NoC decodes the address and transports the request transaction to the target. The target handles the request transaction and sends a response transaction back to the initiator via the NoC. Such communication is packet-based.

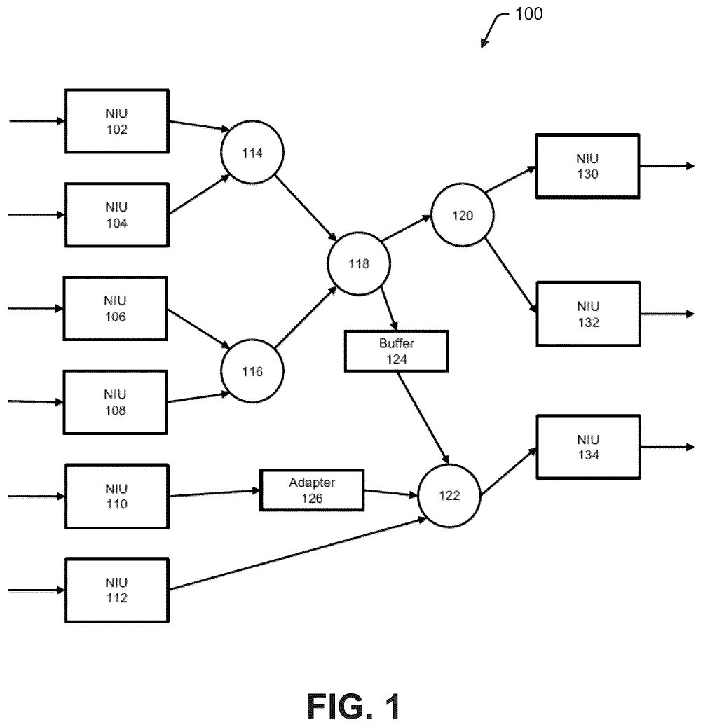

Referring now to FIG. 1, an example network-on-chip (NoC) 100 is shown. The NoC 100 includes NIUs 102, 104, 106, 108, 110, 112, 130, 132, and 134. NIUs connected to initiators are referred to as initiator NIUs or INIUs, and NIUs connected to targets are referred to as target NIUs or TNIUs. The NIUs 102, 104, 106, 108, 110, 112, 130, 132, and 134 convert the protocols used by their connected initiators and targets into the transport protocol used inside the NoC 100.

The NoC 100 further includes switches such as switches 114, 116, 118, 120, and 122; adapters such as adapter 126; and buffers such as buffer 124. The switches 114, 116, 118,120, and 122 route flows of traffic between the initiators and the targets. The buffers insert pipelining elements to span long distances, or to store packets to deal with rate adaptation between fast senders and slow receivers or vice-versa. The adapters handle various conversions between data width, clock domains, and power domains.

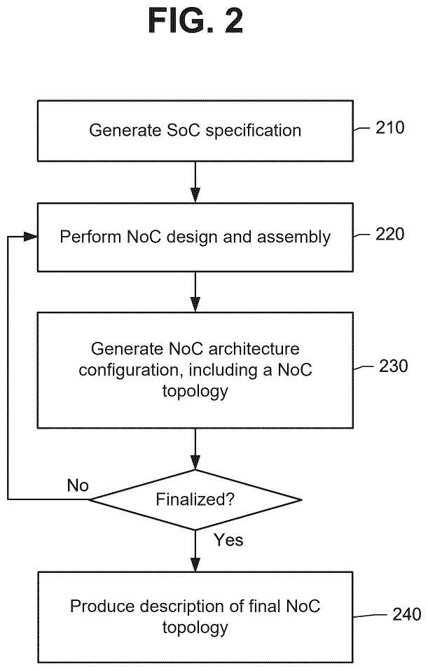

Reference is now made to FIG. 2, which illustrates a general method of designing a NoC. At block 210, an SoC specification is generated. The SoC specification provides a chip definition, technology, domains and layout for an SoC. The SoC specification also defines the real estate for the NoC and other NoC constraints. The SoC layout may include the locations of initiators and targets.

At block 220, NoC design and assembly are performed. IP blocks are selected from a NoC library, and the selected IP is instantiated. In addition, IP connection and assembly, sockets configuration, and end-to-performance capture may be performed. This stage produces a NoC specification that defines SoC IPs and their related sockets and protocols, along with the communication flows between initiators and targets, and memory maps.

At block 230, an architecture configuration of the NoC is generated. This includes NoC topology synthesis: generating a simplistic NoC topology and modifying the NoC topology in accordance with a reinforcement learning method herein. NoC elements such as switches, buffers, firewalls, pipelines and rate adapters are added to the NoC topology. Power, Performance and Area (PPA) tradeoffs may be performed (unit duplication is decided together with size of buffers in switches for example).

Generating the architecture configuration is an iterative process. A loop from block 230 back to block 220 helps in finalizing the architecture configuration by changing the settings of parameters, changing connectivity schemes (e.g., from a mesh to crossbar or modified mesh), enabling of safety through unit duplication, etc.

A NoC design may have to satisfy different performance requirements, such as connectivity and latency between source and destination, frequency of various NoC elements, maximum area available for NoC logic and its associated routing (wiring), minimum throughput between initiators and targets, power consumption requirements, and positions. Multiple iterations of the NoC topology may be generated until the different performance requirements are satisfied.

At block 240, a final NoC topology description is produced, for instance, in a computer-readable file or done through a user interface, in graphical or textual form. The description may be stored in computer memory, ready for use by software.

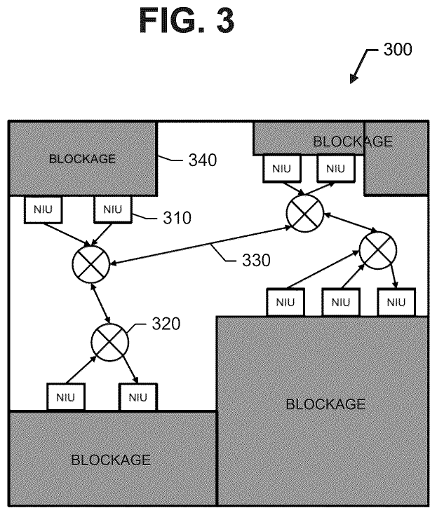

Referring now to FIG. 3, a NoC topology 300 is shown with various NoC elements, such as NIUs 310 and switches 320. The NoC topology 300 shows various connectivity elements 330 through various switches 320. The NoC topology 300 also shows constraints such as blockage areas 340 (that is, areas where the NoC elements cannot be placed and wire connections cannot be routed).

In some of the examples that follow, the same reference may be used for an initiator or an NIU connected to an initiator. Thus “M1” may refer to initiator M1 or the NIU connected to initiator M1. Similarly, the same reference may be used for a target or an NIU connected to a target. Thus “S1” may refer to target S1 or the NIU connected to target S1.

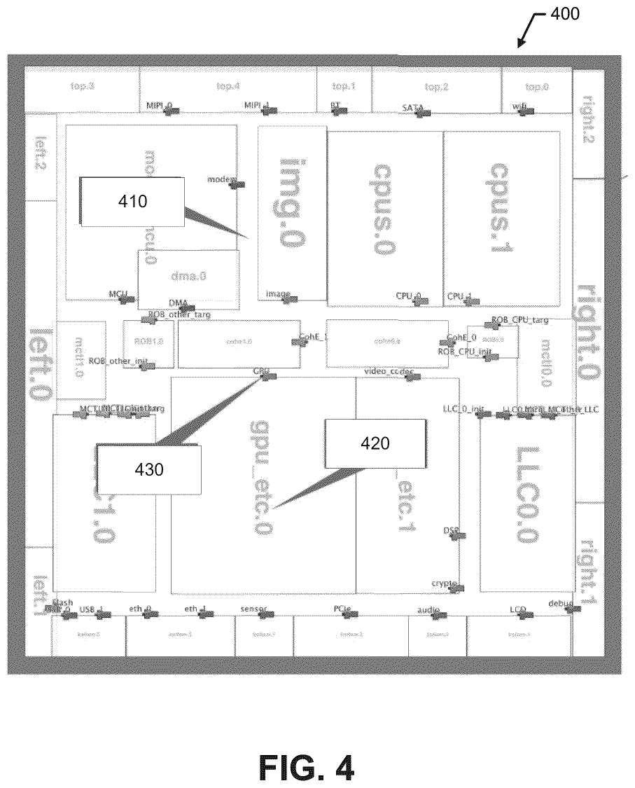

Referring now to FIG. 4, which shows an example floorplan 400 of an SoC onto which a NoC will be implemented. The floorplan 400 identifies IP blocks of the SoC, such initiators and targets. The floorplan 400 identifies free space 410 and blockage areas 420. The blockage areas 420 refer to areas in which the NoC elements are not allowed to be placed. The free space 410 refers to areas of SoC where the NoC elements are allowed to exist. The floorplan 400 also identifies the positions of interfaces 430 to the NoC, such as initiator NIUs and target NIUs.

The initiators and targets of an SoC may be characterized by many different parameters. Some parameters might define data bus widths for wire connections used to send write requests and receive write responses. Other parameters might include, but are not limited to, wire delay and/or logic density, clock domain crossing (CDC), performance requirements, connectivity requirements, and communication policy.

Parameters may also define clock and power domains to which the initiators and targets belong. A clock domain is defined by the logic fed by a given clock input. The clock input may characterized by clock frequency. A power domain is defined by all logic getting power from the same power source. If a power source is gated, a power domain can be isolated from other power domains. The SoC may include multiple clocks domains and multiple power domains.

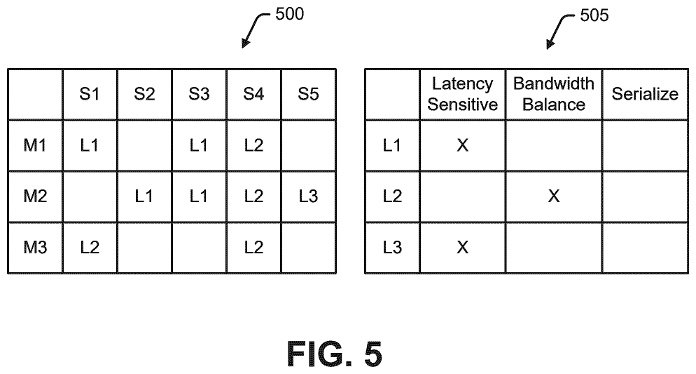

FIG. 5 shows an example connectivity table 500 that may be used to specify NoC connectivity. In some embodiments, the connectivity table 500 allows for traffic to be defined by classification. The connectivity table 500 can enable the use of a traffic class label for each connection between an initiator and a target. In the example connectivity table 500, there are three traffic classes labeled as L1, L2, and L3. A traffic class label is an arbitrary label, chosen by the user or designer. The number of labels that can be defined is not limited to a specific number. Each label represents the need for independent network resources. A distinct subnetwork may be assigned to each label, which can be physically different, or virtual networks, if supported by the underlying NoC technology.

A precise definition of the target that can receive requests from an initiator is outlined or set forth in the connectivity table 500. As shown in the connectivity table 500, an initiator is not required to send requests to all of the targets.

In the connectivity table 500, each initiator is assigned a row and each target is assigned a column. If a given initiator is specified to send traffic to a given target, a traffic class label is presented at the intersection of the given initiator row and the given target column. If no label is present at the intersection, then there is no connectivity between that given initiator and that given target. For example, initiator M1 is connectively communicating with target S1 per a defined label L1. However, initiator M1 does not communicate with target S2, and hence there is no label at the intersection of initiator M1 and target S2.

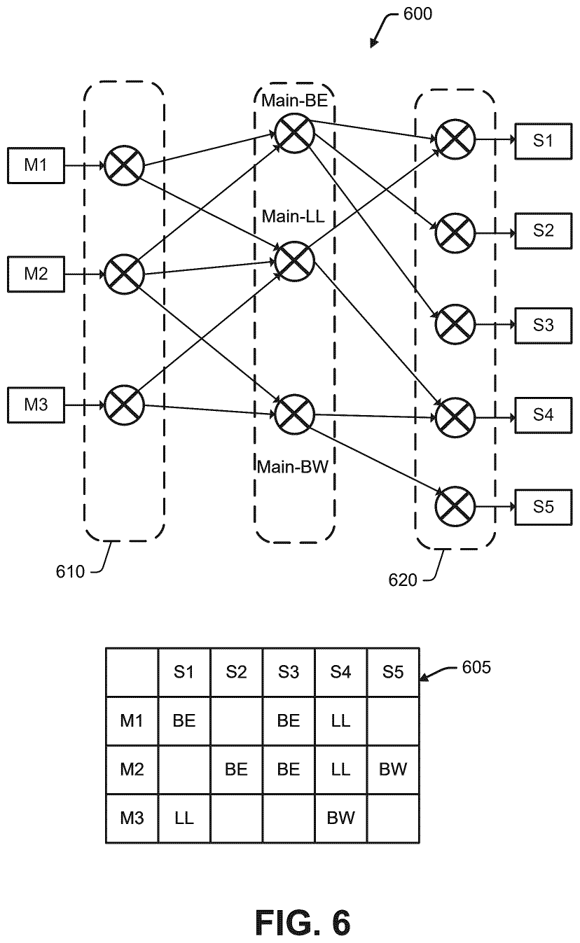

FIG. 6 illustrates an example of creating a simplistic NoC topology 600. The simplistic NoC topology 600 implements a connectivity table. For example, the simplistic NoC topology 600 implements the connectivity table 605 with the following defined parameters and NoC elements:
one initiator NIU per initiator;
one target NIU per target;
one switch per defined traffic class, called the main switch of the class;
one switch after each initiator NIU to route traffic to those main switches that the corresponding initiator needs to reach, and
one switch before each target NIU to merge traffic from the different main switches that are sending traffic to that target.

In the example of FIG. 6, the connectivity table 605 indicates three traffic class labeled as BE, LL and BW. The simplistic NoC topology 600 includes three initiator NIUs M1, M2 and M3, and five target NIUs S1, S2, S3, S4 and S5. Since there are three traffic classes, there are three main switches Main_BE, Main_LL and Main_BW. The simplistic NoC topology 600 further includes three switches 610 after the three initiator NIUs M1-M3, and five switches 620 before the five target NIUs S1-S5.

Data width of each switch, and the clock domain it belongs to may be computed using the data width of each connected NIU, and their clock domain.

This simplistic NoC topology is fully routed, correct and deadlock-free. However, it is not optimal.

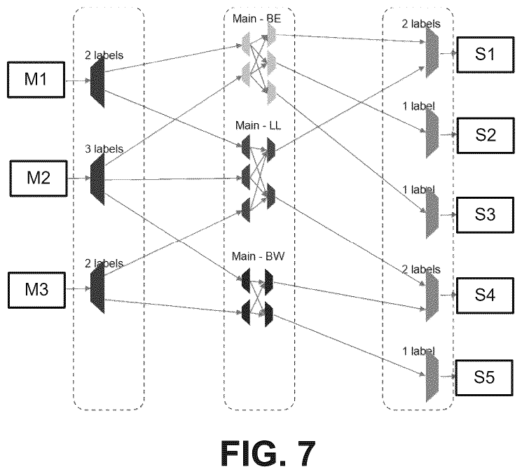

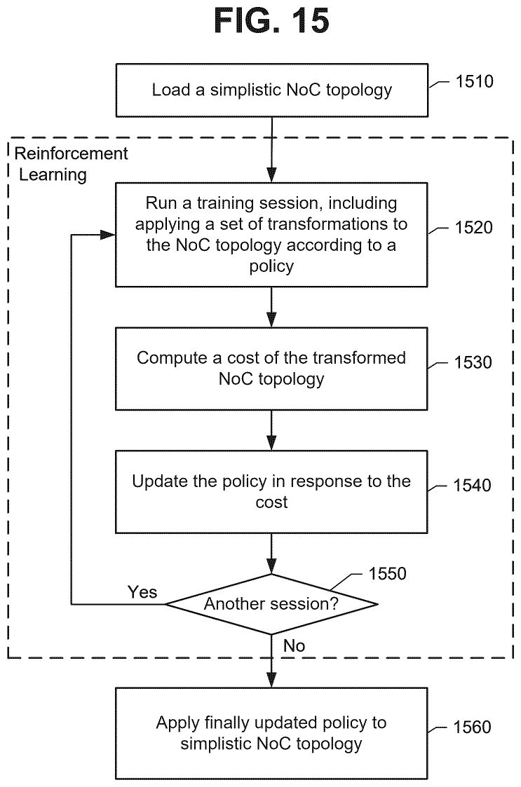

FIGS. 7-13B illustrate different examples of transformations that can be performed on a NoC topology. FIG. 15 illustrates the use of reinforcement learning to use these and other transformations to start with a simplistic NoC topology and find a sequence of transformations that improve upon the simplistic NoC topology.

Reference is now made to FIG. 7. Each main switch of the simplistic NoC topology 600 is decomposed into an equivalent implementation with splitters and mergers. Some main switches may have a single ingress port and multiple egress ports. Some main switches may have multiple ingress ports and a single egress port. During main switch decomposition, each main switch ingress port results in a splitter, and each main switch egress port results in a merger. The splitters and mergers created from each main switch are connected together according to the connectivity table 605.

Reference is now made to FIG. 8, which shows a NoC topology 800. FIG. 8 shows a physical path 802 for initiator NIU M0. This physical path 802, called a splitter roadmap, is computed between the initiator NIU M0 and each of its connected target NIUs S0, S1, S2, and S3. Although not shown in FIG. 8, a splitter roadmap is provided for each other initiator NIU M1, M2 and M3.

An algorithm may be used to find a path between an initiator NIU and its connected target NIUs. The algorithm may attempt to find minimum path length.

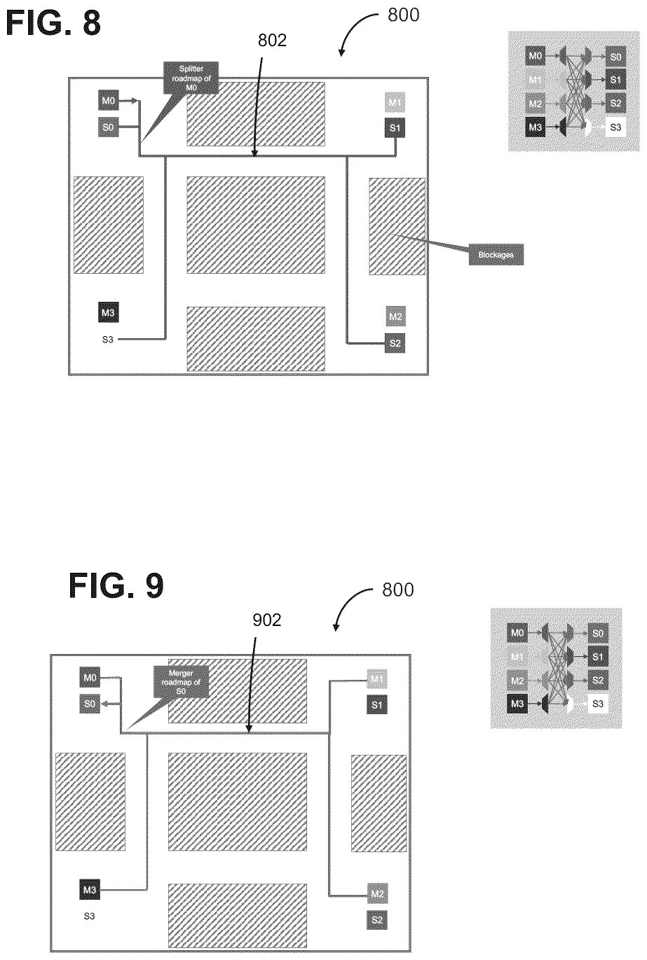

FIG. 9 shows the NoC topology 800 with a computed a physical path 902 between a target NIU S0 and each of its connected initiator NIUs M0, M1, M2 and M3. The physical path 902 is called a merger roadmap of the target NIU S0. Although not shown in FIG. 9, a merger roadmap is provided for each other target NIU S1, S2 and S3. An algorithm may be used to find a physical path between a target NIU and its connected initiator NIUs. The algorithm may attempt to find minimum path length.

FIG. 10 shows the NoC topology 800 with a path 1002 after main switch decomposition. Each main switch is decomposed into mergers and splitters. Each main splitter is decomposed into a cascade of splitters. Each splitter of the cascade is placed on a branching point. FIG. 10 illustrates the branching points for path 1002 as each point where the path 1002 is split into two or more branches.

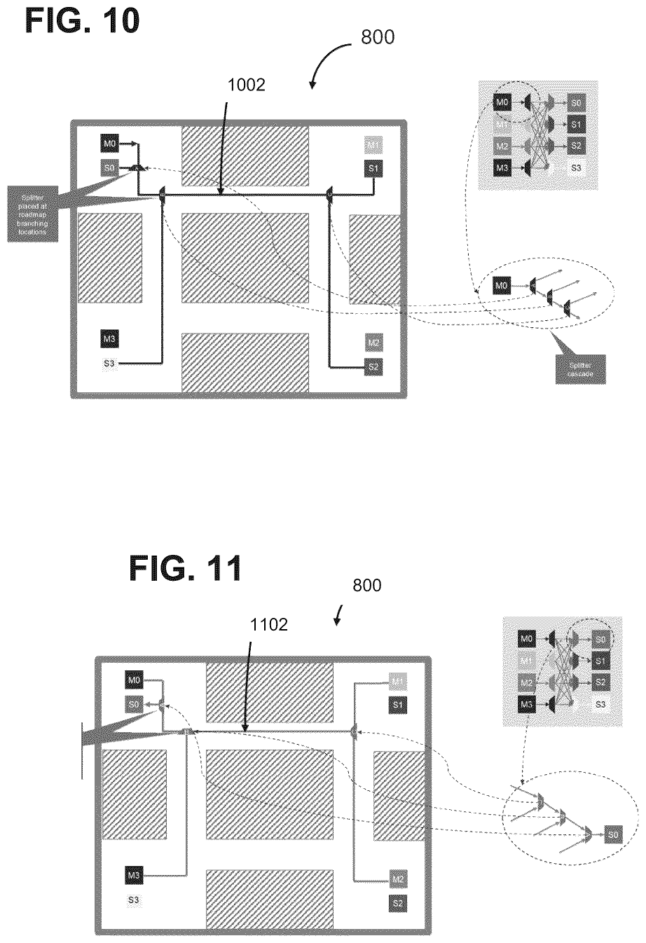

FIG. 11 shows the NoC topology 800 with a path 1102 corresponding to a merger roadmap. Each merger is decomposed into a cascade of mergers. Each merger of the cascade is placed on a branching point of the merger roadmap. FIG. 11 illustrates the branching points for path 1102 as each point where the path 1102 is split into two or more branches.

The process of decomposing a splitter in a cascade of splitters preserves the original splitter functionality, as the number of inputs to the cascade is still one, and the number of outputs of the cascade is identical to the number of outputs of the original splitter. The process of decomposing a merger in a cascade of mergers preserves the original merger functionality, as the number of outputs of the cascade is still one, and the number of inputs to the cascade is identical to the number of inputs to the original merger. Advantageously, the decomposition results in a set of elementary switches that are physically placed close to where the actual connections between switches need to be.

Switches may be fused under the condition that performances are still met. The cost function may consider metrics such as wire length, logic area, power, and performance. Two switches may be fused if the gain in terms of at least one metric is maximized.

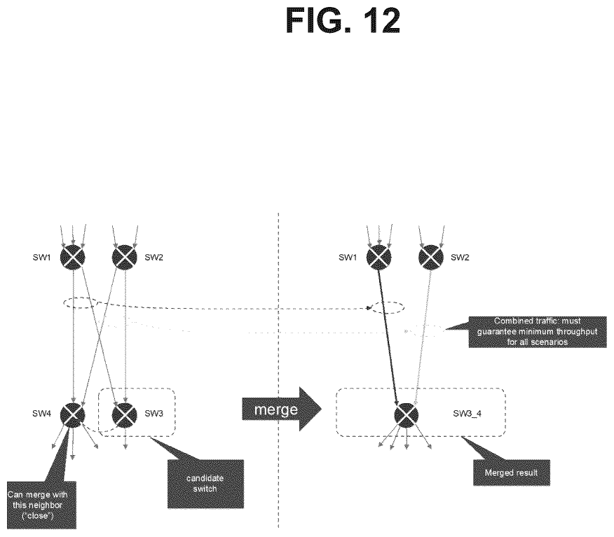

Reference is made to FIG. 12, which illustrates fusion of neighboring switches SW3 and SW4. Switch SW3 is selected as a candidate for fusion, and switch SW4 is identified as a neighbor of switch SW3. When the switches SW3 and SW4 are fused, the wire connections that were going from switches SW3 and SW4 are simplified into a single wire connection to the resulting single switch SW3_4. For example, a first wire connection from switch SW1 to switch SW3 and a second wire connection from switch SW1 to switch SW4 are combined into a single wire connection from switch SW1 to fused switch SW3_4. Advantageously, long connections between distant switches (e.g., switches SW1 and SW2) are removed and reduced to a minimum, while connections between neighboring switches are removed and made inside the switch themselves.

Various other optimizations may be performed to further reduce the number of wire connections in the NoC topology, the area of the NoC elements, and power consumed by the NoC elements. Examples of such optimization include: detection of wire connections that can be removed because they are not used, or their traffic can be re-routed; reducing the width of a wire connection if the wire connection is wider than required by the scenarios; and performing wire length optimization through finding an optimal placement of all the NoC elements that minimizes the total wire length, where the total wire length of the NoC topology is the sum of the distance spanned by each wire connection between NoC elements times the width of that connection.

Locations of the NoC elements may be modified so that (a) the NoC elements fit within the free space and do not overlap, and (b) the NoC elements exist within their corresponding clock and power domain limits.

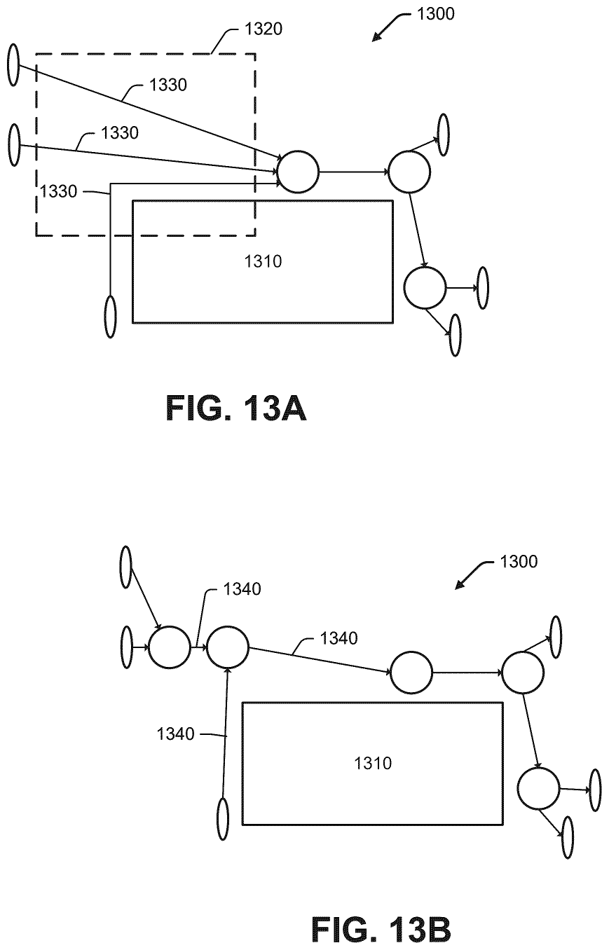

FIG. 13A and FIG. 13B illustrate wire optimization on a subnetwork 1300 with a blockage area 1310 and NoC elements placed in free space, which is outside the blockage area 1310. Wire length will be optimized by improving wire sharing between the segments going in the same direction.

In FIG. 13A, region 1320 identifies wire segments 1330 for replacement. The segments 1330 go in the same direction. The region 1320 may be identified algorithmically, manually by a user, or by a trained machine learning model.

FIG. 13B shows the segments 1330 replaced with a combination of switches and new segments 1340 to implement wire sharing between segments going in the same direction. Wire length of the segments 1340 in FIG. 13B is less than wire length of the segments 1330 in FIG. 13A.

A modification to the NoC topology may involve the insertion of NoC elements other than switches. Firewalls may be inserted. Various adapters and buffers may also be inserted. The insertion of adapters may be based on the adaptation for two NoC elements that have different data width, different clock and power domains. The insertion of buffers may be based on the scenarios and detected rate mismatch.

The use of reinforcement learning will now be discussed. First, a general description of reinforcement learning will be provided. Then the use of reinforcement learning for NoC topology optimization will be described.

In general, reinforced learning refers to a sub-category of machine learning in which an agent learns to make decisions by interacting with an environment to maximize reward through trial and error. The environment is the training situation that the agent will attempt to optimize. A “state” of the environment refers to a configuration of the environment at a given time.

The agent includes the machine learning model being trained to take actions that optimize the environment. A policy determines how the agent behaves at any time, acting as a mapping between an action to the current state.

The reward acts as the agent's performance metric and is used to evaluate the environment after a sequence of decisions have been applied.

During a training session, the agent perceives the current state of the environment, and selects an action to perform according to its policy. In response to the action, the environment transitions to a new state. After a sequence of actions have been performed, a reward is determined. The agent updates its policy in response to the reward.

Multiple training sessions are performed and the policy is iteratively updated. The goal of the reinforcement learning is to find a policy that maximizes the reward.

Reinforcement learning may be adapted to NoC topology optimization as follows. The environment is the NoC topology. In some embodiments, a state of the NoC topology may be described by a list. For example, a list may provide names of all NoC elements in the topology, positions (e.g., x,y coordinates) of the NoC elements, and routes through the NoC elements.

In other embodiments, the NoC topology may be represented by a graph of nodes and edges. Nodes in the graph represent NoC elements, and edges represent the connectivity. Information encoded in the nodes may include position of the associated NoC element. Additional information may include clock domain and power domain. The edges represent logical and/or physical connections. Information encoded in the edges may include length, data width, clock domain, power domain, and traffic type. An edge may have additional information, such as identifying the route or routes that go through the edge.

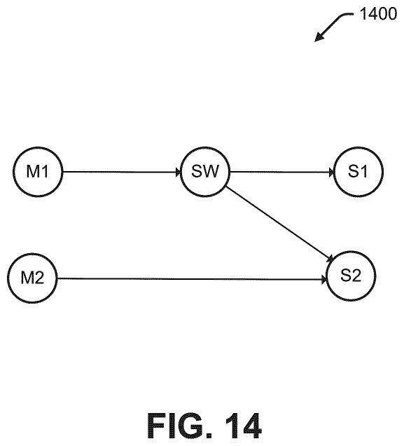

An example of a graph 1400 is illustrated in FIG. 14. The graph 1400 represents a simplistic NoC topology having two initiator NIUs M1 and M2, two target NIUs S1 and S2, and a single switch SW. Edges of the graph 1400 indicate that initiator NIU M1 can send packets to both target NIUs S1 and S2, and that initiator NIU M2 can send packets only to target NIU S2.

The agent includes a machine learning model that is able to perform a set of actions. An action may include a topology transformation. Physical topology transformations include, without limitation, inserting a NoC element, deleting a NoC element, moving a NoC element to a new position, splitting a switch, fusing switches, and inserting switches to share connections. Some of these transformations are described above in connection with FIGS. 7-13B. Logical transformations include, but are not limited to, setting clock frequency, and setting a data path width.

The reward, hereinafter cost, is determined by a cost function. The cost function may be based on one or more parameters, such as wire length, cell congestion, and wire density.

Reference is now made to FIG. 15, which shows a method of using reinforcement learning to optimize a NoC topology. At block 1510, a simplistic NoC topology is loaded. The simplistic NoC topology is fully routed. In some embodiments, the simplistic NoC topology is also deadlock-free.

Generation of the simplistic NoC topology may follow the approach described above in connection with FIG. 6. If there is a single traffic class, the simplistic NoC topology will have a single main switch, one switch per initiator NIU, and one switch per target NIU. The simplistic NoC topology will also implement a connectivity table. If this approach is followed, the simplistic NoC will be fully routed and deadlock free.

At blocks 1520 to 1550, reinforcement learning is performed on the NoC topology to identify a sequence of topology transformations that will produce a more optimal NoC topology. The transformations are not limited to any particular subset. In some embodiments, however, the transformations are not allowed to make existing routes unrouted, and they are not allowed to move NoC elements outside of the free space. Thus, the NoC topology always remains fully routed.

In some embodiments, the transformations are not allowed to introduce cyclic dependencies. Cyclic dependencies can cause potential deadlocks. Thus, the transformations would not allow, for example, a segment resulting in a cycle (e.g., a route that starts and ends at the same NoC element) to be added.

Advantageously, the agent avoids having to “learn” certain difficult concepts in NoC design, such as connectivity, packet routing and deadlock avoidance. The agent also avoids having to dynamically determine whether these constraints are satisfied. If the simplistic NoC topology is the fully routed, the NoC topology will remain fully routed during the transformations. If the simplistic NoC topology is deadlock-free, the NoC topology will remain deadlock-free during the transformations.

At block 1520, a training session is run. During a training session, a machine learning model (the agent) applies a set of transformations to the NoC topology according to a policy. The policy acts as a mapping between an action to the current state of the NoC topology.

At block 1530, a cost of the transformed NoC topology is computed.

At block 1540, the policy is updated in response to the cost. Updating the policy includes changing the weights of the machine learning model in order for the machine learning model to be better a better estimator in subsequent training sessions.

If additional training sessions are desired (block 1550), control is returned to block 1520. Another training session is run, but this time with the updated policy.

At block 1560, after the training sessions have concluded, exploration of a more optimal policy ends, and exploitation begins. The policy that was repeatedly updated during the training sessions (the “finally updated policy”) is now applied to the simplistic NoC topology. Transformations per the finally updated policy are applied to the simplistic NoC topology to produce a more optimal NoC topology.

In some embodiments, the machine leaning model may be a large language model or other natural language processing model. Such a machine learning model can process a NoC topology represented by a list of NoC elements.

In some embodiments, the machine learning model may be a graph neural network (GNN). Such a machine learning model can process a NoC topology represented by a graph. The GNN receives a current graph representing a current state of the NoC topology, applies a transformation or set of transformations that are predicted (according to its weights) to improve the cost, and produces the next state of the NoC topology.

An action space encompasses the number of possible actions that can be taken on a NoC topology. Take a simple example of a simplistic NoC topology including an initiator NIU, a target NIU, and a single connection between the initiator NIU and the target NIU. The number of possible actions is few, and one of the few actions might include inserting a switch. For the next state, which includes the switch, the number of possible actions is greater, as it may include removing the switch, splitting the switch, connecting a new NoC element to the switch, etc.

The action space is discrete, and the number of actions is bounded. Continuous-space algorithms such as Deep Deterministic Policy Gradient (DDPG) and Soft Actor-Critic (SAC) may be used to optimize the action space by defining each action as an input to a function that outputs a “score” for the input action. This is particularly advantageous for an action space that changes in size. The action space will increase in size as NoC elements are added to the NoC topology.

In some embodiments, the agent may include a search algorithm to reduce the number of possible transformations to apply during a training session. The search algorithm learns and directions and discards them, and follows the good directions. After a cost is computed at the end of a training session, the cost may be used as a measure of how good the machine learning model was at orienting the search algorithm to the most interesting part of the action space. That is, the search algorithm can guide the machine learning model to adjust its heuristic (e.g., the degree of exploration) so cost after the next training session is improved.

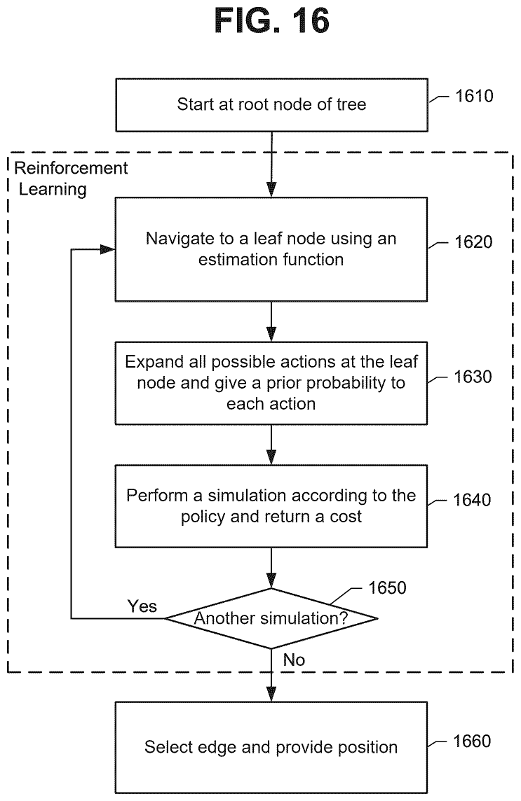

An example tree search algorithm is illustrated in FIG. 16. A tree represents the action space. A root node of the tree represents a current state of the NoC topology.

A leaf node represents a next state of the NoC topology. Thus, each node of the tree search is a graph, which represents a state of the NoC topology. A branch represents a transformation that causes the current state to transition to the next state. An expansion of a leaf node represents the expansion of the action space.

Reference is now made to FIG. 16. Let p(a|s) be a policy function that outputs a recommended action (a), given the current state(s). Let V(s) be a value function that estimates the final cost attained by the policy.

At block 1610, the search starts at the root node. At block 1620, the search navigates to a leaf node using s=argmax Q(s,a)+u(s,a), where (s,a) is the next edge to traverse, and u is a heuristic controlling the degree of exploration. The function Q(s,a) provides an estimation based on state s and a value of action a.

At block 1630, once at a leaf node, all possible next actions are expanded, giving a prior probability p(a|s_leaf) to each action. At block 1640, using policy, a simulation is performed and a cost value V(s) is returned.

At block 1650, after N simulations have been performed, the edge (root_node, a) that maximizes the expected return is selected (block 1660). A sub-tree whose root node is now the selected node is returned.

A selected edge corresponds to a selected transformation. A position on the NoC topology may be provided with the selected edge (block 1660). For example, another policy network may be responsible for choosing a position on the NoC topology according to the selected transformation.

In some embodiments, the agent may access a machine learning model instead of executing a search algorithm. The machine learning model receives the current state as an input, predicts the transformations to apply to the current state, and provides the next state as an output. The machine learning model may be an auto-regressive model. Predictions by the auto-regressive model are conditioned on what already has been generated. Examples of the auto-regressive model include a graph neural network and a graph-transformer model.

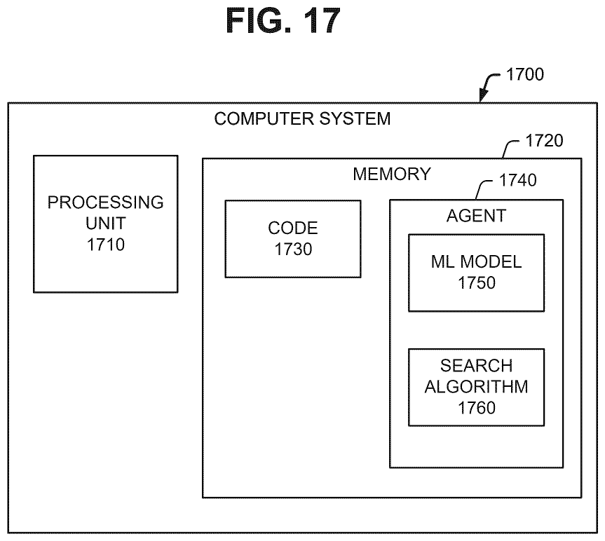

FIG. 17 illustrates a computer system 1700 configured to use reinforcement learning to optimize a NoC topology. The computer system 1700 includes a processing unit 1710 and computer-readable memory 1720 encoded with code 1730 that, when executed, causes the computer system 1700 to load a simplistic NoC topology and perform reinforcement learning as described herein. The simplistic NoC topology may be retrieved from the memory 1720 or it may be accessed remotely and stored in the memory 1720, or it may be generated and stored in the memory 1720.

The code 1730 may also guide the operation of an agent 1740, which may also be stored in the memory 1720. The agent 1740 includes a machine learning model 1750 and, optionally, a search algorithm 1760. The code 1730 may be responsible for providing states to the machine learning mode 1750, computing the cost, and updating the policy.

In some embodiments, the code 1730 and the agent 1740 may be part of an application, such as an electronic computer aided design (ECAD) tool. In some embodiments, the ECAD tool may be integrated into a larger program.

Certain methods according to the various aspects of the invention may be performed by instructions that are stored upon a non-transitory computer readable medium. The non-transitory computer readable medium stores code including instructions that, if executed by one or more processors, would cause a system or computer to perform steps of the method described herein. The non-transitory computer readable medium includes: a rotating magnetic disk, a rotating optical disk, a flash random access memory (RAM) chip, and other mechanically moving or solid-state storage media. Any type of computer-readable medium is appropriate for storing code including instructions according to various example.

Certain examples have been described herein and it will be noted that different combinations of different components from different examples may be possible. Salient features are presented to better explain examples; however, it is clear that certain features may be added, modified and/or omitted without modifying the functional aspects of these examples as described.

Various examples are methods that use the behavior of either or a combination of machines. Method examples are complete wherever in the world most constituent steps occur. For example, and in accordance with the various aspects and embodiments of the invention, IP elements or units include: processors (e.g., CPUs or GPUs), random-access memory (RAM—e.g., off-chip dynamic RAM or DRAM), a network interface for wired or wireless connections such as ethernet, WIFI, 3G, 4G long-term evolution (LTE), 5G, and other wireless interface standard radios. The IP may also include various I/O interface devices, as needed for different peripheral devices such as touch screen sensors, geolocation receivers, microphones, speakers, Bluetooth peripherals, and USB devices, such as keyboards and mice, among others. By executing instructions stored in RAM devices processors perform steps of methods as described herein.

Some examples are one or more non-transitory computer readable media arranged to store such instructions for methods described herein. Whatever machine holds non-transitory computer readable media including any of the necessary code may implement an example. Some examples may be implemented as: physical devices such as semiconductor chips; hardware description language representations of the logical or functional behavior of such devices; and one or more non-transitory computer readable media arranged to store such hardware description language representations. Descriptions herein reciting principles, aspects, and embodiments encompass both structural and functional equivalents thereof. Elements described herein as coupled have an effectual relationship realizable by a direct connection or indirectly with one or more other intervening elements.

Practitioners skilled in the art will recognize many modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection or indirect connection, which uses one or more other intervening elements. Embodiments described herein as “communicating” or “in communication with” another device, module, or elements include any form of communication or link and include an effectual relationship. For example, a communication link may be established using a wired connection, wireless protocols, near-filed protocols, or RFID.

To the extent that the terms “including”, “includes”, “having”, “has”, “with”, or variants thereof are used in either the detailed description and the claims, such terms are intended to be inclusive in a similar manner to the term “comprising.”

The scope of the invention, therefore, is not intended to be limited to the exemplary embodiments shown and described herein. Rather, the scope and spirit of present invention is embodied by the appended claims.

What is claimed is:

1. A computer-implemented method comprising:
loading a simplistic network-on-chip (NoC) topology that is fully routed; and
performing reinforcement learning on the NoC topology to identify a sequence of topology transformations that will produce a more optimal NoC topology, wherein performing the reinforcement learning includes running a plurality of training sessions, wherein running each training session includes:
using a machine learning model to apply a set of transformations to the NoC topology according to a policy;
computing a cost of the NoC topology after the set of transformations has been applied; and
updating the policy in response to the cost.

2. The method of claim 1, further comprising, after the training sessions have concluded and the policy has been finally updated, applying a set of transformations to the simplistic NoC topology according to the finally updated policy.

3. The method of claim 2, wherein the simplistic NoC topology includes a plurality of initiator and target network unit interfaces; and wherein the transformations according to the finally updated policy add a plurality of switches to the simplistic NoC topology.

4. The method of claim 1, wherein the transformations are not allowed to make existing routes unrouted and are not allowed to move NoC elements outside of free space.

5. The method of claim 1, wherein the simplistic NoC topology is deadlock-free; and wherein the transformations are not allowed to introduce cyclic dependencies.

6. The method of claim 1, wherein the cost is based on wire length.

7. The method of claim 1, wherein possible transformations to perform on a current state of a NoC topology form a discrete action space; and wherein a continuous-space algorithm is used to optimize the discrete action space.

8. The method of claim 1, wherein the machine learning model is a graph neural network (GNN) that receives a current graph representing a current state of the NoC topology; wherein the GNN applies a transformation or set of transformations, and produces a graph representing a next state of the NoC; and wherein the cost of the next state is determined.

9. The method of claim 1, wherein running each training session further includes using a search algorithm and the cost from a previous training session result to find transformations that are predicted to reduce the cost in a current training session.

10. The method of claim 9, wherein a tree search algorithm is used to return a selected transformation in a sub-tree, and also a position on the NoC topology with respect to the selected transformation.

11. An electronic computer aided design (ECAD) tool comprising computer-readable memory encoded with code for designing a network-on-chip (NoC) topology, wherein the code, when executed by a computer system, causes the computer system to:
load a simplistic network-on-chip (NoC) topology that is fully routed; and
perform reinforcement learning on the NoC topology to identify a sequence of topology transformations that will produce a more optimal NoC topology, wherein the reinforcement learning includes running a plurality of training sessions, wherein running each training session includes:
using a machine learning model to apply a set of transformations to the NoC topology according to a policy;
computing a cost of the NoC topology after the set of transformations has been applied; and
updating the policy in response to the cost.

12. The tool of claim 11, wherein the code, when executed, further causes the tool to apply a set of transformations to the simplistic NoC topology according to a finally updated policy.

13. The tool of claim 12, wherein the simplistic NoC topology includes a plurality of initiator and target network unit interfaces; and wherein the transformations according to the finally updated policy add a plurality of switches to the simplistic NoC topology.

14. The tool of claim 11, wherein the transformations are not allowed to make existing routes unrouted and are not allowed to move NoC elements outside of free space.

15. The tool of claim 11, wherein the simplistic NoC topology is deadlock-free; and wherein the transformations are not allowed to introduce cyclic dependencies.

16. The tool of claim 11, wherein the cost is based on wire length.

17. The tool of claim 11, wherein the machine learning model is a graph neural network (GNN) that receives a current graph representing a current state of the NoC topology; wherein the GNN applies a transformation or set of transformations, and produces a graph representing a next state of the NoC; and wherein the cost of the next state is determined.

18. The tool of claim 11, wherein running each training session further includes using a tree search algorithm to find sub-trees of transformations that are predicted to reduce the cost in the training session.

19. A computer system comprising a processing unit; and computer memory encoded with code that, when executed by the processing unit, causes the computer system to:
load a simplistic network-on-chip (NoC) topology that is fully routed; and
perform reinforcement learning on the NoC topology to identify a sequence of topology transformations that will produce a more optimal NoC topology, wherein performing the reinforcement learning includes running a plurality of training sessions, wherein running each training session includes:
using a machine learning model to apply a set of transformations to the NoC topology according to a policy;
computing a cost of the NoC topology after the set of transformations has been applied; and
updating the policy in response to the cost.

20. The computer system of claim 19, wherein the simplistic NoC topology is deadlock-free; and wherein the transformations are not allowed to introduce cyclic dependencies.
